(19) United States
(12) Patent Application Publication
(10) Pub. No.: US 2016/0299261 A1
(43) Pub. Date: Oct. 13, 2016

(54) Methods for Manufacturing Laminated Film and Articles Made Therefrom

(71) Applicant: Angel 7 Industries, LLC, San Antonio, TX (US)

(72) Inventor: Kerry S. Harris, San Antonio, TX (US)

(21) Appl. No.: 14/742,445

(22) Filed: Jun. 17, 2015

Related U.S. Application Data
(63) Continuation-in-part of application No. 14/681,261, filed on Apr. 8, 2015.

(51) Int. Cl. G02B 1/14; F41H 1/02; B29C 45/16; B32B 27/08; B32B 27/36

(52) U.S. Cl. CPC G02B 1/14; B32B 27/08; B32B 27/365; B29C 45/1679; F41H 1/02; B32B 2307/412; B32B 2571/02; B32B 2551/00; B29K 2069/00

(57) ABSTRACT

The present invention relates to methods of manufacturing laminated film and article made therefrom, such as eyeshields, faceshields and lenses. Specifically, the methods of the present invention laminate a film or plastic layer with a protective layer via an invention laminating process. The process may further be utilized to add materials, such as, for example, photochromic material to optically transparent material. Preferably, photochromic material is adhered to optically transparent material in a hot molding process.

The present invention claims priority to U.S. paten application Ser. No. 14/681,261, titled “Methods for Manufacturing Articles Comprising Photochromic Film,” filed Apr. 8, 2015, which is incorporate herein by reference in its entirety.

### TECHNICAL FIELD

The present invention relates to methods of manufacturing laminated film and article made therefrom, such as eyeshields, faceshields and lenses. Specifically, the methods of the present invention laminate a film or plastic layer with a protective layer via an invention laminating process. The process may further be utilized to add materials, such as, for example, photochromic material to optically transparent material. Preferably, photochromic material is adhered to optically transparent material in a hot molding process.

### BACKGROUND

Optically transparent material may have a variety of uses. For example, eyeshields, faceshields and lenses are, of course, generally known optically transparent materials that may provide useful functions to wearers of the same. Specifically, lenses may be utilized in eyeglasses to help correct vision, for example. Indeed, eyeshields, faceshields and lenses may also provide the alternative or additional benefit of protecting a user's eyes or face from harm, which may come from physical sources, such as impacts from ballistics, explosions, or other like sources or harm, or from unseen sources, such as from radiation from the sun.

Indeed, eyeshields, faceshields and lenses are commonly used in helmets, such as sports helmets, motorcycle helmets, goggles, bicycle face shields, protective eyewear, and other like apparatuses. Eyeshields, faceshields and lenses may simply comprise a layer of plastic held in place over a user's eyes and/or face. Thus, the eyeshields, faceshields and lenses operate to protect a user's eyes and face from debris or other like airborne material.

Oftentimes, protective eyewear, such as eyeshields, faceshields and lenses are utilized to prevent debris, projectiles, or other like elements from damaging a wearer's eyes or other body parts. Typically, a very strong, optically clear plastic is used to prevent debris from contacting a wearer's eyes or other body parts. Oftentimes, optically transparent material is desired because protective eyewear may often be worn indoors, and a wearer may wish to see as clearly and as unencumbered as possible.

However, it is often difficult for a thin, plastic material to provide sufficient protection. Wearers may face situations where debris and other projectiles may penetrate the wearer's eyewear, in which case the eyewear failed to provide adequate protection. In extreme cases, protective eyewear often fails to protect eyewear from ballistics. Moreover, flying debris or projectiles, such as ballistics, may cause protective eyewear to shatter, and the shards from the protective eyewear may damage a user's eyes or other body parts. A need, therefore, exists for plastic film that may be utilized as protective eyewear, such as eyeshields, faceshields, and lenses that provide increased protection against flying debris or other like projectiles, including ballistics. More specifically, a need exists for laminated film and methods of making the same that may be utilized for articles, such as a protective eyewear, eyeshields, faceshields, body armor, or other like articles that may protect sensitive body parts.

Moreover, certain materials may be useful for certain purposes, but may ultimately be particularly weak for projectile protection. For example, materials that are often used for laser eye protection often are manufactured by materials that offer good to excellent protection from lasers, but typically do not offer good protection against flying debris or projectiles, such as ballistics. A need, therefore exists for laminated films and articles made therefrom that have adequate protection from flying debris or projectiles, such as ballistics, and also offer protection for other purposes where traditionally weaker materials are typically needed.

It is often the case that to make an article having adequate protection against flying debris or projectiles, such as ballistics, the article made therefrom must be relatively thick, cumbersome, heavy and difficult to use or relatively uncomfortable to wear. A need exists for laminated films and articles made therefrom that do not require relatively thick, cumbersome, heavy, difficult to use or uncomfortable to wear. In addition, materials that may be utilized as eyeshields or other protective articles trade off optical clarity for protection against flying debris or other like projectiles. A need, therefore, exists for laminated films and articles made therefrom that maintain optical clarity.

Moreover, plastic films that may be utilized as eyeshields, faceshields, lenses or other like protective articles may tend to scratch or abrade when used repeatedly. A need, therefore, exists for laminated films and articles made therefrom that may be protected from scratches or abrasions during use thereof. Moreover, films utilized in eyeshields, faceshields, lenses, or other like protective articles may further have coatings thereon for such as chemically resistant layers, anti-fog layers, hard-coat layers, clear coat layers, hydrophobic chemical layers, or other like coatings or materials. A need, therefore, exists for laminated films and articles made therefrom that may incorporate other coatings therein.

A useful application for plastic films or other like articles is in use in eyewear that protects a user from harmful radiation, such as from the sun or other like sources, using photochromic coatings or layers. Specifically, eyeshields, faceshields and lenses may be in the form of glasses or other protective eyewear that may aid a user's vision and/or protect the user from harmful radiation, such as from the sun or other sources. Commonly, sunglasses are used by individuals to decrease the amount of visible or invisible radiation from entering a user's eyes. For example, in many cases, user's wear sunglasses to combat the brightness of the sun or from other like sources. In addition, user's wear sunglasses for protecting against harmful ultraviolet radiation from the sun or other like sources.

Often, users of eyeshields, faceshields and lenses must move from areas of brightness to areas of relative darkness. Indeed, in many cases members of the military or police force must traverse between areas of high brightness, such as outside under the bright sun, and inside, such as in buildings and the like rapidly. To protect a user's eyes in such a situation, photochromic film may be used.

Photochromic film or photochromic material darkens upon exposure to certain types of light, such as ultraviolet light. Common photochromic materials utilize a transparent substrate, such as glass or plastic, having embedded therein or coated thereon silver halide particles or molecules. Silver chloride molecules are most commonly used as photochromic material. Upon exposure to ultraviolet light, for example, the photochromic materials absorb the radiation and darken, which subsequently blocks the transmission of visible and invisible light through the substrate. Removal from the ultraviolet light subsequently causes the photochromic material to lighten, allowing more light to pass therethrough. Thus, photochromic material, such as film, is used on eyeshields, faceshields and lenses where a user may traverse outside to inside, and vice versa.

Typically, photochromic material is added to transparent substrates by “flow coating” the photochromic material onto the surface of the eyeshields, faceshields and/or lenses. Specifically, the eyeshield, faceshield or lens is manufactured, and the photochromic material is disposed over the surface of the eyeshield or lens and then baked on.

The flow coating method, however, suffers from serious drawbacks. Specifically, the bond between the photochromic material and the transparent substrate is typically fairly weak, and the photochromic material may become scratched or otherwise removed from the substrate material fairly easily. Moreover, the photochromic material may not be embedded within a substrate and as such may simply sit on the outside surface of the eyeshield, faceshield or lens, which may also contribute to the ease of scratching or otherwise removing the photochromic material from the surface of the eyeshield, faceshield or lens.

A need, therefore, exists for an eyeshield, faceshield or lens having a resilient photochromic material incorporated therewith. Specifically, a need exists for an eyeshield, faceshield or lens where the photochromic material may be protected and provide its functional use thereon.

Moreover, a need exists for an eyeshield, faceshield or lens made by a process that more securely holds the photochromic material on or in a substrate. More specifically, a need exists for an eyeshield, faceshield or lens made by a process where the photochromic material may be embedded within a film that may be tightly adhered to a transparent substrate.

Further, a need exists for an eyeshield, faceshield or lens made by a process that is quicker and less costly than heretofore known methods. Still further, a need exists for an eyeshield, faceshield or lens that may be utilized in many applications, such as in motorcycle helmets and faceshields, bicycle faceshields and lenses, military lenses and faceshields, law enforcement face shields and lenses, pilot faceshields, sports glasses, safety glasses, industrial faceshields, and other like applications.

### SUMMARY OF THE INVENTION

The present invention relates to methods of manufacturing laminated film and article made therefrom, such as eyeshields, faceshields and lenses. Specifically, the methods of the present invention laminate a film or plastic layer with a protective layer via an invention laminating process. The process may further be utilized to add materials, such as, for example, photochromic material to optically transparent material. Preferably, photochromic material is adhered to optically transparent material in a hot molding process.

To this end, in an embodiment of the present invention, a method of making an article is provided, the method comprises the steps of: providing a mold having an internal surface; placing an amount of protective film within the mold on the internal surface; closing the mold so that the protective film is disposed within the mold on the internal surface injecting melted material into the mold to form a shaped article; and cooling the shaped article, wherein the shaped article comprises a protective film bonded thereto.

In an embodiment, the method further comprises the step of cutting the shaped article into a final shape.

In an embodiment, the protective film comprises a functional material embedded therein.

In an embodiment, the protective film comprises an optically transparent film having a first surface and a second surface, and a functional material coated to the first surface of the optically transparent film.

In an embodiment, the protective film is placed within the mold such that the second surface contacts the internal surface of the mold and the first surface coated with functional material contacts the melted material when injected into the mold.

In an embodiment, the protective film takes on the shape of the internal surface of the mold prior to injecting with melted material.

In an embodiment, the melted material is selected from the group consisting of a thermoplastic material, a thermoset material, glass, rubber, ceramic and metal.

In an embodiment, the melted material is a thermoplastic material selected from the group consisting of polycarbonate, polyacrylic, polyurethane, polyvinyl acetate, polyvinyl chloride, polyvinylidene chloride, polyethylene, polypropylene and combinations thereof.

In an embodiment, the melted material is polycarbonate.

In an embodiment, the shaped article is optically transparent when cooled.

In an embodiment, the method further comprises the step of: cutting protective film to form a shape of the protective film prior to placing the shape of the photochromic film in the mold.

In an embodiment, the method further comprises the step of sizing the protective film and cutting the protective film to form a shape of protective film such that the shape of the protective film is roughly the size of the shaped article prior to placing the shape of the protective film into the mold.

In an embodiment, the shaped article is selected from the group consisting of an eyeshield, a faceshield, and a lens.

In an embodiment, the present invention comprises a shaped article.

In an embodiment, the protective film is bonded to a surface of the shaped article.

In an embodiment, the functional material is disposed between the protective film and the melted material.

In an embodiment, the functional material is in a layer between the optically transparent film and the melted material.

It is, therefore, an advantage and objective of the present invention to provide plastic film that may be utilized as protective eyewear, such as eyeshields, faceshields, and lenses that provide increased protection against flying debris or other like projectiles, including ballistics.

More specifically, it is an advantage and objective of the present invention to provide laminated film and methods of making the same that may be utilized for articles, such as a protective eyewear, eyeshields, faceshields, body armor, or other like articles that may protect sensitive body parts.

Moreover, it is an advantage and objective of the present invention to provide laminated films and articles made therefrom that do not require relatively thick, cumbersome, heavy, difficult to use or uncomfortable to wear.

Further, it is an advantage and objective of the present invention to provide laminated films and articles made therefrom that maintain optical clarity.

Still further, it is an advantage and objective of the present invention to provide laminated films and articles made therefrom that may be protected from scratches or abrasions during use thereof.

In addition, it is an advantage and objective of the present invention to provide \laminated films and articles made therefrom that may incorporate other coatings therein.

Moreover, it is an advantage and objective of the present invention to provide an eyeshield, faceshield or lens having a resilient photochromic material incorporated therewith.

Specifically, it is an advantage and objective of the present invention to provide an eyeshield, faceshield or lens where the photochromic material may be protected and provide its functional use thereon.

Moreover, it is an advantage and objective of the present invention to provide an eyeshield, faceshield or lens made by a process that more securely holds the photochromic material on or in a substrate.

More specifically, it is an advantage and objective of the present invention to provide an eyeshield, faceshield or lens made by a process where the photochromic material may be embedded within a film that may be tightly adhered to a transparent substrate.

Further, it is an advantage and objective of the present invention to provide an eyeshield, faceshield or lens made by a process that is quicker and less costly than heretofore known methods.

Still further, it is an advantage and objective of the present invention to provide an eyeshield, faceshield or lens that may be utilized in many applications, such as in motorcycle helmets and faceshields, bicycle faceshields and lenses, military lenses and faceshields, law enforcement face shields and lenses, pilot faceshields, sports glasses, safety glasses, industrial faceshields, and other like applications.

Additional features and advantages of the present invention are described in, and will be apparent from, the detailed description of the presently preferred embodiments and from the drawings.

### BRIEF DESCRIPTION OF THE DRAWINGS

The drawing figures depict one or more implementations in accord with the present concepts, by way of example only, not by way of limitations. In the figures, like reference numerals refer to the same or similar elements.

FIG. 1 illustrates a method of bonding photochromic film to a transparent thermoplastic substrate having a circular shape in an embodiment of the present invention.

FIG. 2 illustrates an article having a photochromic film bonded thereto in an embodiment of the present invention.

FIG. 3 illustrates a method of bonding photochromic film to a thermoplastic substrate having a spherical shape in an embodiment of the present invention.

FIG. 4 illustrates a method of bonding photochromic film to a thermoplastic substrate having a cylindrical shape in an embodiment of the present invention.

FIG. 5 illustrates a method of bonding photochromic film to a thermoplastic substrate having an irregular shape in an embodiment of the present invention.

### DETAILED DESCRIPTION OF THE PRESENTLY PREFERRED EMBODIMENTS

The present invention relates to methods of manufacturing laminated film and article made therefrom, such as eyeshields, faceshields and lenses. Specifically, the methods of the present invention laminate a film or plastic layer with a protective layer via an inventive laminating process. The process may further be utilized to add materials, such as, for example, photochromic material to optically transparent material. Preferably, photochromic material is adhered to optically transparent material in a hot molding process.

Preferred methods of the present invention bond a transparent, protective film to a transparent, translucent or opaque thermoplastic material, a thermoset material, a glass material, a ceramic material, a rubber material, a metal material, or other like material for strengthening the same or to provide the application of useful materials, such as photochromic material or other like materials, as described herein. In a preferred embodiment, the transparent, protective film may be a layer of polycarbonate that may be applied to a substrate in the manner described herein. The use of polycarbonate adds substantial strength and impact resistance to films and articles made therefrom.

Preferable substrates to which the transparent, protective film may be bonded may include, but may not be limited to, polycarbonate, polyacrylic, polyurethane, polyvinyl acetate, polyvinyl chloride, polyvinylidene chloride, polyethylene, such as high density polyethylene, polypropylene, combinations thereof or any other like transparent thermoplastic material. Other materials may include ceramic, rubber, nylon, metal, glass, or other like materials, whether transparent, translucent or opaque.

The present invention comprises a method for bonding a transparent, protective film to a transparent, translucent or opaque substrate, as described herein. The transparent, protective film and the substrate may form an article for use in protecting a wearer of the same. The method generally comprises a first step of measuring the shape and size of the protective film necessary to provide full coverage of the substrate. The protective film may be any film useful for laminating in the methods provided herein. For protective films, a preferred material may be polycarbonate. Other films may be utilized having other functions, such as transparent thermoplastic films having photochromic particles embedded therein. Of course, the protective film material should be resilient to survive the hot-molding process, as disclosed below. Moreover, the protective film may be bendable or flexible to take the shape of the desired article, as described below.

Specifically, the protective film, in a first step, may be sized against a blank to ensure that the protective film is sufficiently sized. In a second step 14, the protective film may be cut via any known method, such as die cut, to form the desired size and shape. In a third step, the die cut film may be placed within a mold, and the protective film may be oriented to ensure that the desired surfaces face the proper direction. For example, it may be desired that one surface of the protective film face inwardly as the bonding surface to the transparent thermoplastic material bonded thereto.

Specifically, if the protective film comprises another useful material, such as photochromic material or other like material, the useful material may be coated onto the transparent thermoplastic or thermoset film. The surface having the useful material coated thereon may be the bonding surface for the transparent thermoplastic substrate. This may ensure that the photochromic material is not exposed to be scratched or otherwise removed from the film.

After the protective film is placed in a mold and the mold is closed upon the film, the film will generally take the shape of the mold due its bendability and resiliency. In a fourth step, melted material may be injected into the mold, such as melted thermoplastic material that acts as the substrate to which the protective film is bonded. In a preferred embodiment, hot melted polycarbonate thermoplastic material may be injected into the mold to form an article when cooled. When cooled in a fifth step, the article may thus have the protective film securely bonded thereto, and taking the shape of the article. In a sixth step, the article may be taken out of the mold and other coatings may be applied to the article, such as, for example, hardcoat and/or anti-fog coatings, as desired. In a seventh step, the article may be cut into the desired final shape and utilized in a finished part.

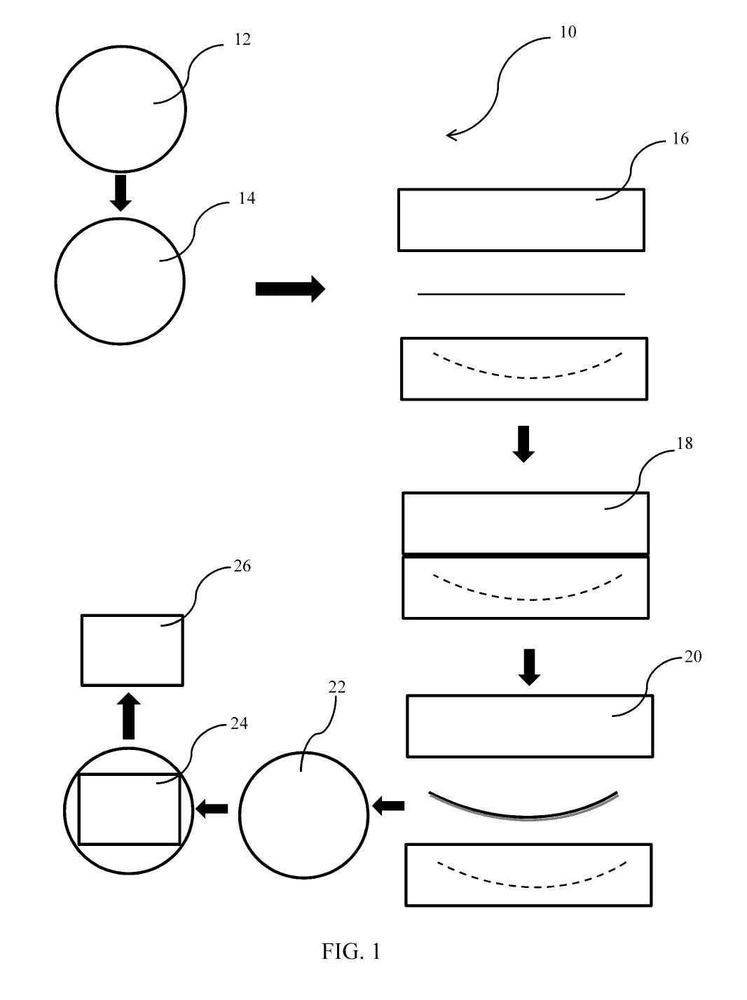

Now referring to the figures, wherein like numerals refer to like parts, FIG. 1 illustrates a method 10 for bonding a transparent, protective film to a transparent thermoplastic or thermoset substrate having a circular shape. The method 10 comprises a first step of measuring the shape and size of protective film necessary to provide full coverage of the transparent substrate. The protective film may be any film. Preferably, the protective film may be made from polycarbonate. In another embodiment, the protective film may comprise photochromic material. Specifically, the protective film should be resilient to survive the hot-molding process, as disclosed below. Moreover, the protective film may be bendable or flexible to take the shape of the desired eyeshield, faceshield or lens, as described below.

Preferably, the substrate may be an optically transparent material, although it should be noted that the methods described herein may also be utilized on translucent or opaque substrates as well. The optically transparent substrate to which the protective film is bonded may preferably be any thermoplastic material known to one of ordinary skill in the art that may be useful for receiving the protective film, as disclosed herein. Exemplary transparent thermoplastic substrates may include, but may not be limited to, polycarbonate, polyacrylic, polyurethane, polyvinyl acetate, polyvinyl chloride, polyvinylidene chloride, polyethylene, including high density polyethylene, polypropylene, combinations thereof or any other like transparent thermoplastic material. Alternately, the optically transparent substrate may be made of any other rigid transparent material, such as glass, transparent or translucent ceramic, or other like materials, as apparent to one of ordinary skill in the art.

In a preferred embodiment of the present invention, the protective film may comprise photochromic particles. The photochromic particles may be made from any photochromic material apparent to one of ordinary skill in the art. Commonly, silver halide particles, such as silver chloride particles, are utilized as photochromic material that may be embedded in transparent thermoplastic or thermoset film to form the photochromic film. Alternatively, the photochromic particles may be embedded within a thin layer of glass. Alternatively, the photochromic material may be coated to a transparent thermoplastic or thermoset film or glass.

The protective film may further comprise other materials, such as electronic components, including but not limited to circuits. For example, small flex circuits, such as liquid crystal activation circuits, or other like circuits, may be incorporated into the protective film and applied to the substrates as disclosed herein. Alternatively, circuits may be disposed between the protective film and the substrate, whereupon the protective film protects the circuits from exposure.

Specifically, the protective film, in a first step 12, may be sized against a blank to ensure that the protective film is sufficiently sized. In a second step 14, the protective film may be cut via any known method, such as die cut, to form the desired size and shape. In a third step 16, the die cut protective film may be placed within a mold, and the protective film may be oriented to ensure that the desired surfaces face the proper direction. For example, it may be desired that one surface of the protective film face inwardly as the bonding surface to the transparent thermoplastic material bonded thereto. Specifically, if a useful material or coating, such as the photochromic material, is coated onto the protective film, then the surface having the useful material coated thereon may be the bonding surface for the substrate. This may ensure that the useful material is not exposed to be scratched or otherwise removed from the film.

After the protective film is placed in a mold and the mold is closed upon the film, the film will generally take the shape of the mold due its bendability and resiliency. In a fourth step 18, melted material may be injected into the mold, such as melted thermoplastic material. Preferably, hot melted polycarbonate thermoplastic material may be injected into the mold to form an article when cooled. When cooled in a fifth step 20, the article may thus have the protective film securely bonded thereto, and taking the shape of the article. In a sixth step 22, the article may be taken out of the mold and other coatings may be applied to the article, such as, for example, hardcoat and/or anti-fog coatings, as desired.

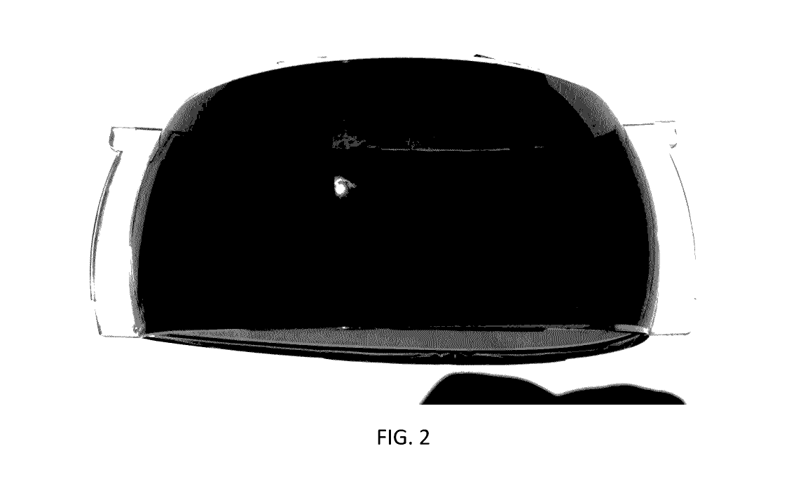

In a seventh step 24, the article may be cut into the desired final shape and utilized in a finished part, as shown in eighth step 26. For example, FIG. 2 illustrates a finished article having a protective material bonded thereto in the process specified above.

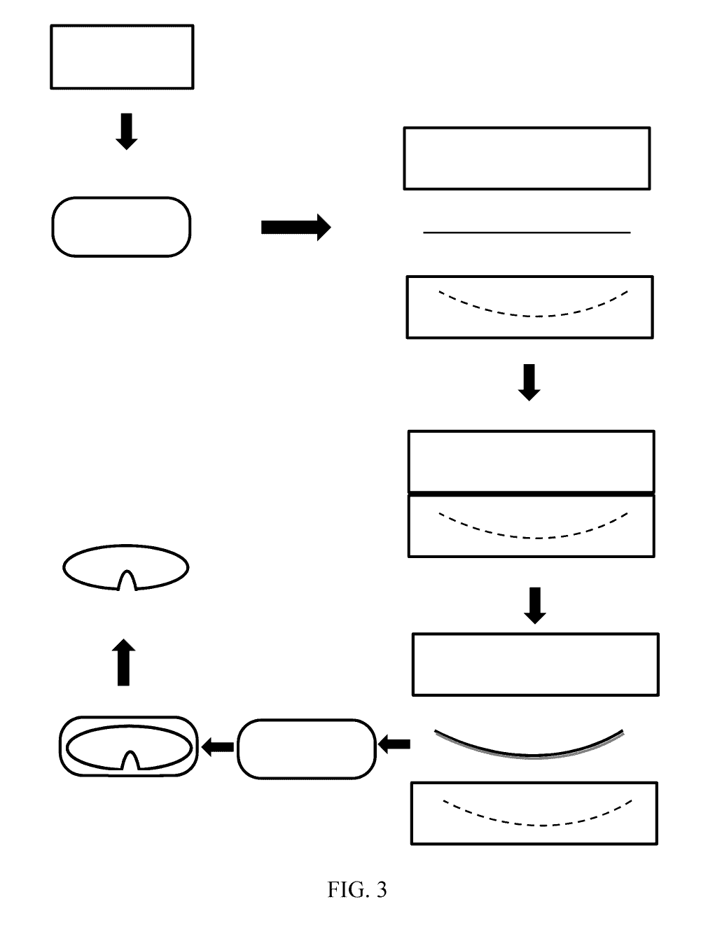

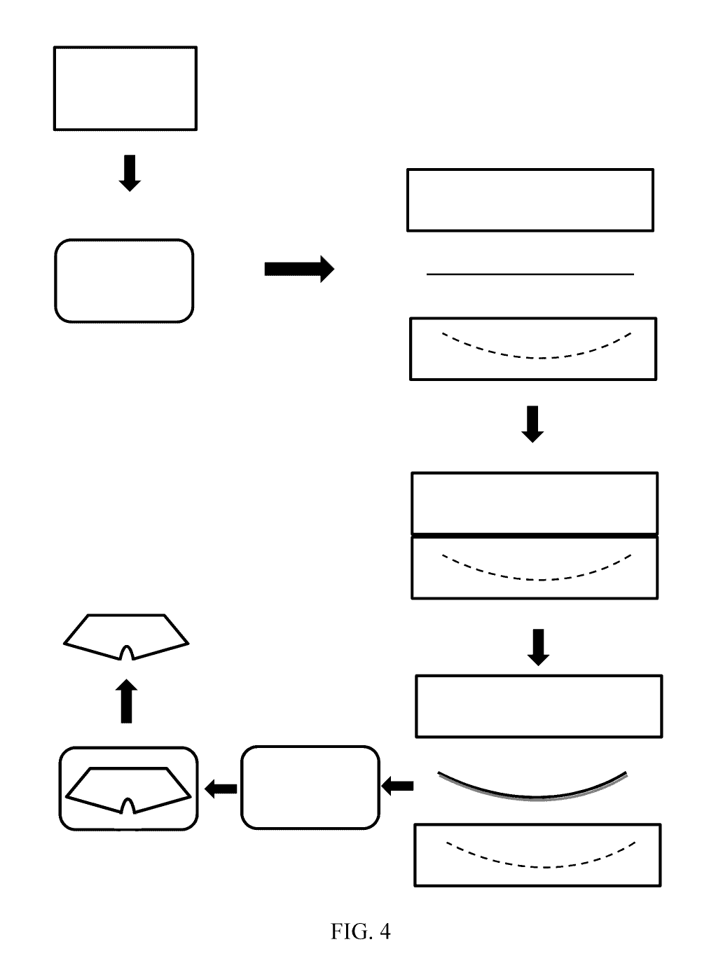

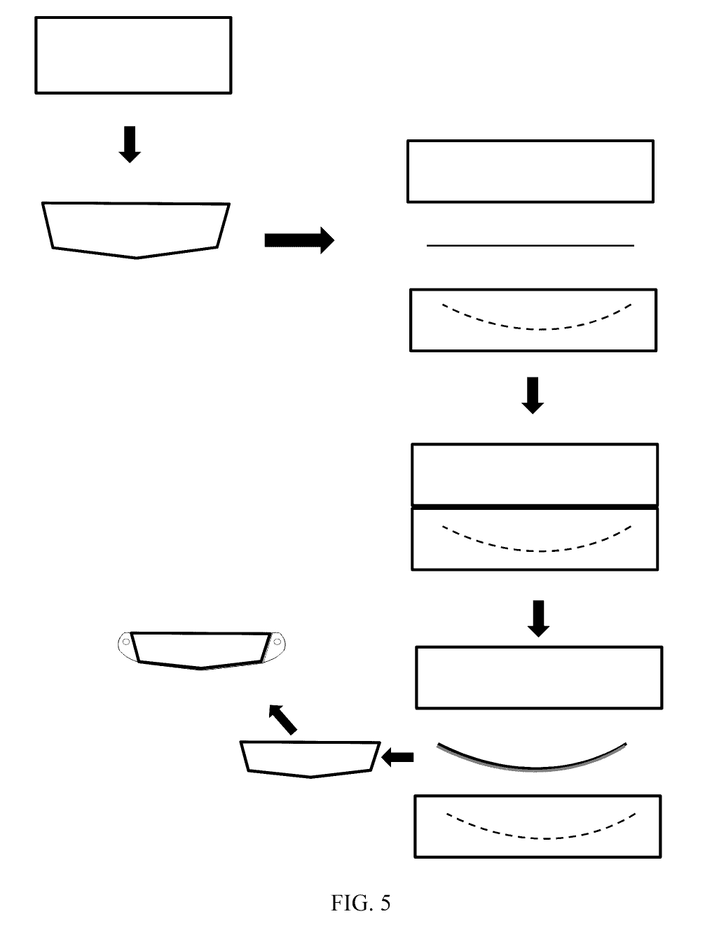

FIGS. 3-5 illustrate methods for making several other shaped articles, such as spherically-shaped articles (FIG. 3), cylindrically-shaped articles (FIG. 4), and irregularly-shaped articles (FIG. 5). Of course, it should be noted that the present methodology may be utilized to bond protective film to any shaped article that may be made in a hot mold process, and the invention should not be limited as described herein.

Moreover, a double layer, triple layer or plurality of layers may be laminated together using the methods described. Specifically, the present invention may make an article, as described above. However, prior to cutting into the desired shape via the seventh step, the laminated article may be placed into a mold wherein a second protective film may be disposed thereon and the mold may be closed upon the laminated article and the second protective film, whereupon a second molten material may be injected into the mold to bond with the second protective film and the previously made laminated article. Double, triple or multiple layer articles may have increased protective properties, such as increased ballistic capabilities.

As provided herein, eyeshields, faceshields and lenses may be made using the methodology as described above. Of course, these eyeshields, faceshields and lenses may have a plurality of applications, including as motorcycle faceshields and helmet lenses, bicycle faceshields and lenses, in military faceshields and lenses, pilot faceshields, law enforcement faceshields and lenses, auto sports faceshields, such as helmets used in auto racing, sports sunglasses, safety glasses, aviation faceshields and lenses, and in industrial and commercial faceshields and lenses, although the present invention should not be limited as described herein.

Moreover, it should be noted that other method steps may be included for creating patterns in the materials for specific purposes, such as increased ballistics capabilities (by including lattices, patterns, etc.) or for particular tints, such as for aesthetic purposes.

### EXAMPLES

A plurality spherical lens shapes were manufactured according to the process described herein, of a polycarbonate protective film (having a thickness of between about 4 and about 7 microns) onto a substrate of polycarbonate having a thickness of about 2.8 mm. The polycarbonate protective film did not include other materials, such as photochromic materials, or other like functional materials. Likewise, a plurality of cylindrical lens shapes were manufactured according to the process described herein, of a polycarbonate protective film (having a thickness of between about 4 and about 7 microns) onto a substrate of polycarbonate having a thickness of about 3.4 mm. As with the spherical lens shapes, the plurality of cylindrical lens shapes included polycarbonate protective film that did not include other materials, such as photochromic materials, or other like functional materials.

Ballistic results of a 0.15 caliber FSP fired from a Cadex Cannon using helium as a propellant showed that the spherical lens shapes had a V50 value, which is the average of the three highest velocity non-penetrations and 3 lowest velocity penetrations, of about 941 ft/sec. Likewise, the ballistic results showed that the cylindrical lens shapes had a V50 value of about 803 ft/sec.

It should be noted that various changes and modifications to the presently preferred embodiments described herein will be apparent to those skilled in the art. Such changes and modifications may be made without departing from the spirit and scope of the present invention and without diminishing its attendant advantages. Further, references throughout the specification to “the invention” are nonlimiting, and it should be noted that claim limitations presented herein are not meant to describe the invention as a whole. Moreover, the invention illustratively disclosed herein suitably may be practiced in the absence of any element which is not specifically disclosed herein.

We claim:

1. A method of making an article comprising the steps of:
providing a mold having an internal surface;
placing an amount of protective film within the mold on the internal surface;
closing the mold so that the protective film is disposed within the mold on the internal surface
injecting melted material into the mold to form a shaped article; and
cooling the shaped article, wherein the shaped article comprises the protective film bonded thereto.

2. The method of claim 1 further comprising the step of:
cutting the shaped article into a final shape.

3. The method of claim 1 wherein the protective film comprises functional materials.

4. The method of claim 1 wherein the protective film comprises an optically transparent film having a first surface and a second surface, and a functional material coated to the first surface of the optically transparent film.

5. The method of claim 4 wherein the protective film is placed within the mold such that the second surface contacts the internal surface of the mold and the first surface coated with the functional material contacts the melted material when injected into the mold.

6. The method of claim 1 wherein the protective film takes on the shape of the internal surface of the mold prior to injecting with melted material.

7. The method of claim 1 wherein the melted material is selected from the group consisting of a thermoplastic material, a thermoset material, glass, rubber, a ceramic material, and a metal material.

8. The method of claim 1 wherein the melted material is a thermoplastic material selected from the group consisting of polycarbonate, polyacrylic, polyurethane, polyvinyl acetate, polyvinyl chloride, polyvinylidene chloride, polyethylene, polypropylene and combinations thereof.

9. The method of claim 1 wherein the melted material is polycarbonate.

10. The method of claim 1 wherein the shaped article is optically transparent when cooled.

11. The method of claim 1 further comprising the step of:
cutting an amount of protective film into a shape and placing the shape of the protective film into the mold.

12. The method of the claim 1 further comprising the step of:
sizing the protective film and cutting the protective film into a shape such that the shape of the protective film is roughly the size of the shaped article prior to placing the shape of the protective film into the mold.

13. The method of claim 2 further comprising the step of:
sizing the protective film and cutting the protective film to form a shape such that the shape of photochromic is roughly the size of the final shape of the article prior to placing the shape of the photochromic film into the mold.

14. The method of claim 1 wherein the shaped article is selected from the group consisting of an eyeshield, a faceshield, and a lens.

15. The method of clam 2 wherein the final shape is selected from the group consisting of an eyeshield, a faceshield, and a lens.

16. A shaped article made by the method of claim 1.

17. The shaped article of claim 16 wherein the protective film is bonded to a surface of the shaped article.

18. The shaped article of claim 16, wherein the shaped article is selected from the group consisting of an eyeshield, a faceshield, and a lens.

19. A shaped article made by the method of claim 5, wherein the functional material is disposed between the film and the melted material.

20. The shaped article of claim 19 wherein the functional material is in a layer between the optically transparent film and the melted material.
